(19) United States
(12) Patent Application Publication
(10) Pub. No.: US 2017/0026559 A1
(43) Pub. Date: Jan. 26, 2017

(54) Stabilizing Camera Phone Extension

(71) Applicant: Huey Aaron Simmons, Marina Del Rey, CA (US)

(72) Inventor: Huey Aaron Simmons, Marina Del Rey, CA (US)

(21) Appl. No.: 14/808,531

(22) Filed: Jul. 24, 2015

(51) Int. Cl. H04N 5/232; H04M 1/12

(52) U.S. Cl. CPC H04N 5/2328; H04M 1/12

(57) ABSTRACT

A device to enhance the ability of impromptu cell phone filmmakers to make high-quality, watchable videos without sacrificing the flexibility of the cell phone camera video medium. Embodiments of the device stabilize a camera phone while the user records video, using only the shape of the device to enable a natural, steady grip.

### BACKGROUND

Cellular phone cameras have rapidly progressed from an expensive feature of high-end cell phone to a ubiquitous feature on nearly every new cell phone. Camera phone resolution and memory have advanced as well. These days, many people photographing their vacations or just filming recreationally don't have to bother with buying a separate camera; instead, they just use their phone camera. Video recording has increased apace with photographic recording. The prevalence of smartphones and the advance of video recording technology have changed the nature of filming; where once a person had to purchase a video camera and carry it with them to film, now filming is a pastime that almost any person can engage in at a whim.

The significance of this change is difficult to overstate. Particularly among the younger generations, a large and growing fraction of personal entertainment comes in the form of short videos streamed via the Internet. Anyone with a smartphone can make and upload a video to sites such as YOUTUBE™ or to video social media such as VINE™ or PERISCOPE™¹. A significant part of what makes these videos special is their uniquely spontaneous nature. A person can see something interesting and begin filming it in seconds. A decade ago, this kind of impromptu recording would require the coincidental presence of someone carrying a heavy and expensive portable camera, and the ability to distribute that video was limited. Today, a dozen or more people could film and livestream an event in seconds. With today's internet, the videos may be reposted and replayed thousands or even millions of times, especially if one “goes viral”. Websites deriving ad revenue from clicks and traffic benefit from these videos, and the modern glut of these videos stands testament to witness' reaction time and the ubiquity of camera phones. ¹ All third party trademarks are property of their respective owners.

Advances in phone resolution and memory have not addressed one problem—stability. Cell phones are still designed primarily as phones, not cameras, and are designed to be held comfortably to the ear rather than steadily out in front of the user. Cell phone video is shaky and often tilted. It is easy to drop and break an expensive phone while filming. With photographs, shakiness and tilted angles are less of a problem; one can take several photographs and keep the best one, while the tilted angle of popular “selfie” photographs is a signature feature of the style. “Selfie sticks” in the prior art may even exacerbate the tilted angle to create an artistically whimsical effect, and their detrimental effect on camera stability in the extended position does not matter so long as the user can take several still photographs and keep the best ones. However, tilted angles and shaky images are a detriment to video—the viewer gets distracted or even disoriented watching this sort of video. Spontaneous events worth filming may never happen a second time, so multiple takes are not practical Likewise, the risk of dropping the camera is exacerbated, especially if the user walks around while filming. Various products exist to stabilize camera phones during video filming, but the prior art solutions tend to be bulky, heavy, or otherwise unwieldy. Such solutions sacrifice the most advantageous feature of cell phone video over other video cameras: namely, spur-of-the-moment convenience and immediate reaction to unexpected, filmworthy events. Thus, an unaddressed need for a quick-deploying video stabilizing device exists within the field of cell phone videography.

### SUMMARY OF THE INVENTION

The invention, as disclosed herein, is a stabilizing camera phone extension in the form of an attachment to cell phones. Preferred and alternate embodiments are described herein.

The stabilizing camera phone extension is a device specifically designed to hold a modern, flat camera phone firmly attached to a handle, said handle being ergonomically shaped and oriented to be held steady in a user's hand. The product is designed to be as minimalist as possible; it is preferably made to fit in a purse or a pocket, and the user may be able to quickly and easily mount a cell phone to the device. A hallmark of the cell phone video is its convenience and spur-of-the-moment usability; users can see something interesting and begin filming it in seconds. A larger or more complicated device would be useful for planned or scripted film projects by hobbyists, but less useful for impromptu filming by the average user.

To meet these needs, the exemplary embodiment of the stabilizing camera phone extension is kept small and minimalist. It may attach to a cell phone using either a piece of replaceable adhesive or an adjustable sliding gripper. It stabilizes the phone by its shape and the way that the human hand will naturally grasp the device, rather than through the use of any heavy or complex weights and pivots or electronic motorized devices. It is preferably made of stiff, lightweight materials. The device is preferably built small and flat enough to fit in a purse or a pocket.

The cellular phone and its component parts, including the video camera, are not claimed as a feature of this device. Said cell phone is merely an object upon which the device operates.

In a preferred embodiment, the stabilizing camera phone extension is built as a flat and thin unitary body. One end is a paddle shaped like a square with rounded corners; this end is slightly wider than the rest of the device. This paddle comprises two faces; a replaceable adhesive patch on one face mates to a cell phone without covering said cell phone's camera lens. The other end of the device is its handle, rectangular in profile and in cross-section. A user grasps the handle like a pistol grip with one hand and operates the cell phone camera with the other. To use the device, a user presses the back of a cell phone to the adhesive patch for several seconds to secure it in place, hold the device stable like a pistol, activates the video recording function on the cell phone, and films a scene. The user may choose to attach the cell phone upright, horizontally, or at an angle according to the user's desire; this embodiment of the device will hold the camera steady at any angle. The device's shape allows the user to hold the camera phone steady at a natural angle, wherein the user's forearm is parallel to the ground and the user's wrist is straight rather than bent at the awkward angle normally associated with holding a cell phone in its camera mode. This steady wrist and arm position reduces both shakiness and arm fatigue. This advantage is especially pronounced when one compares use of the stabilizing camera phone extension to holding the camera phone horizontally by hand Likewise, the device accommodates the user's entire hand, allowing for greater stability compared to holding the phone's narrow edges with only one's fingertips. The flat profile enables the user to more easily hold the camera phone stable or store the unused device in a purse or pocket.

In an alternate embodiment, the device is built with smooth contours to resemble a wand or television remote control. This alternate embodiment is contoured to be comfortably held in the user's hand like a pistol grip while retaining a flat profile similar to that of the preferred embodiment. This alternate embodiment comprises two pieces, a main body and a sliding grip piece. The sliding grip piece comprises a subordinate body, a slider, and a bottom pincer half. The sliding grip piece can move up or down the length of the main body in order to securely grasp a cell phone; the user operates the sliding grip piece with a thumb. The main body is divided into a paddle and handle, similar to the preferred embodiment. The handle of the main body in this embodiment is partly rectangular in cross-section; the other part of the cross-section is affected by the cutout and protrusion to accommodate the sliding grip piece. In profile the handle is slightly concave relative to the user; the sliding grip piece protrudes from both the front and back of the handle. The top portion of the main body comprises a paddle; the top of the square portion further comprises a top pincer half. In conjunction with the bottom pincer half, the phone securely holds a camera stabile while the user films. The two-piece slider design enables the user to very quickly mount a camera phone between the pincer halves using only one hand on the device and another hand on the phone. The narrow profile allows a user to easily store and carry the device while also allowing the user to firmly grasp and steady the device in one hand.

The foregoing and other features and advantages of the improved vertical axle wind turbine will be apparent to those of ordinary skill in the art from the following more particular description of the invention and the accompanying illustrations.

### BRIEF DESCRIPTION OF THE DRAWINGS

Embodiments of the disclosure will become more fully understood from the detailed description and the accompanying drawings herein Like reference numerals designate corresponding parts throughout the several views.

FIG. 1 is a perspective view of a preferred embodiment.

FIG. 2 is a front view of the preferred embodiment.

FIG. 3 is a side view of the preferred embodiment.

FIG. 4 is a perspective view of an alternate embodiment.

FIG. 5 is a side view of the alternate embodiment.

FIG. 6 is a rear view of the alternate embodiment.

FIG. 7 is a top view of the lower pincer of the alternate embodiment.

FIG. 8 is a side view of the alternate embodiment.

FIG. 9 is a front view of the alternate embodiment.

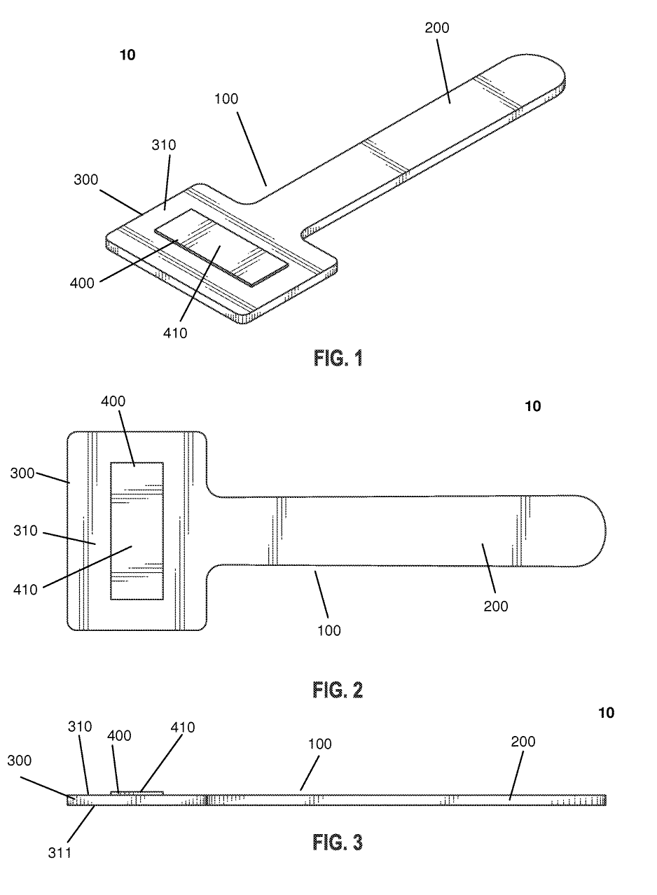

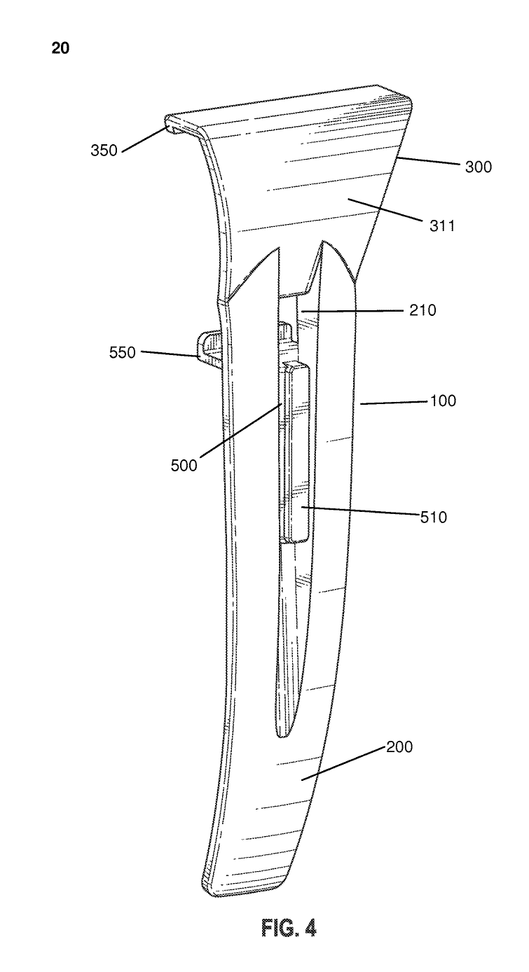

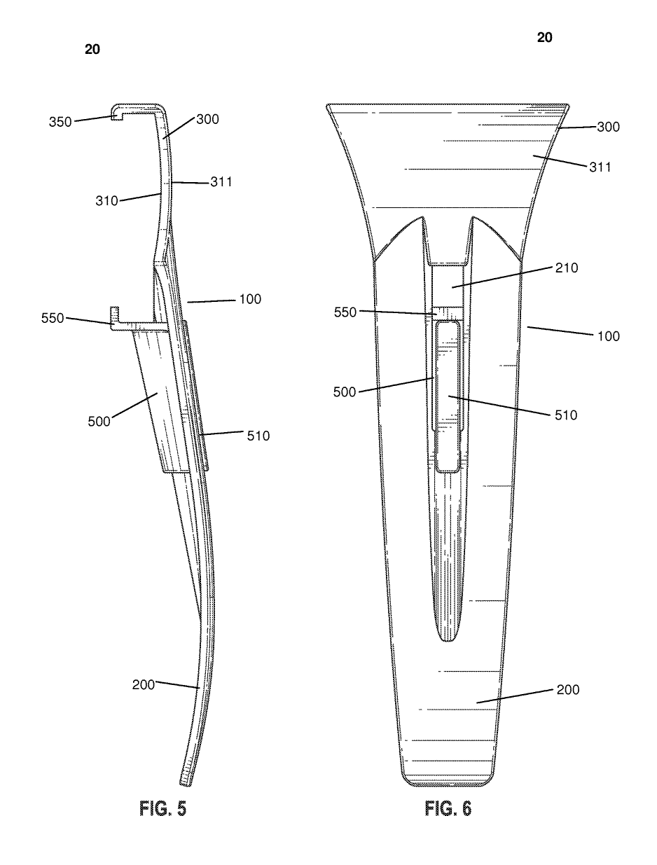

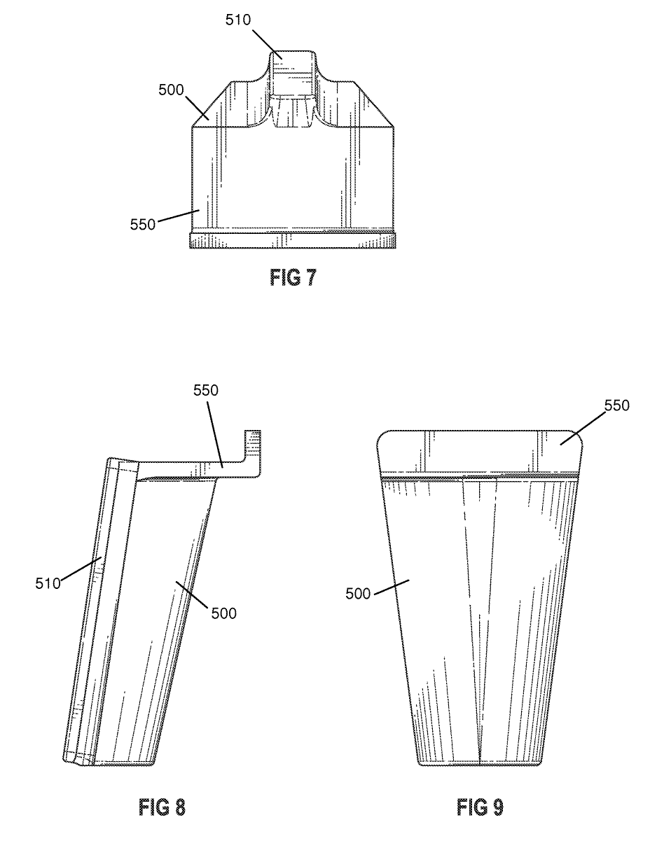

### DETAILED DESCRIPTION

Referring to the figures, a preferred embodiment is the flat phone extension 10. The main body 100 of the flat phone extension 10 is divided into two distinct parts, the handle 200 and the paddle 300. The main body 100 is of uniform thickness throughout. The paddle 300 is broader than the handle 200. The paddle further comprises a first face 310 and a second face 311; the first face 310 adheres to the replaceable adhesive patch 400 while the second face 311 is left blank to enable the user or manufacturer to decorate or otherwise mark said second face 311. In the preferred embodiment, the replaceable adhesive patch 400 comprises an outer surface 410. The replaceable adhesive patch 400 adheres to the first face 310 of the paddle 300 with a strong adhesive. The outer surface 410 of the replaceable adhesive patch 400 comprises a weak adhesive.

The flat phone extension 10 embodiment may alternatively comprise a protective seal over the strong adhesive and/or weak adhesive when the replaceable adhesive patch 400 is not in use. Said protective seal may be color-coded to identify which protective seal belongs over the outer surface 410.

In operation, the user of the flat phone extension 10 adheres the outer surface 410 to the back of a cell phone. Once the cell phone is adhered to the outer surface 410, then user grasps the handle 200 in one hand and holds the flat phone extension 10 upright like a pistol. The user activates the phone's video camera with the other hand; one the user is filming, the user may grasp the handle 200 with one or both hands. When the user wishes to stop filming, the user removes the cell phone from the outer surface 410.

In an alternate embodiment, the phone extension wand 20, the main body 100 of the embodiment is contoured to lean slightly forward in a user's hand. The handle 200 further includes a cutout 210 to which a subordinate body 500 is movably attached. This embodiment lacks a replaceable adhesive patch 400. The paddle 300 of this embodiment further comprises an upper pincer 350 at the top of the first face 310; said upper pincer 350 protrudes from the first face 310 on one side. The subordinate body 500 further comprises a lower pincer 550 at its upper end. Said lower pincer 550 rest opposite to the upper pincer 350 on the paddle 300 of the main body 100. The subordinate body 500 further comprises a slider 510 configured to movably interface with the cutout 210.

The embodiments of the present invention described above, particularly, the preferred embodiments, merely set forth a clear understanding of the principles of the invention. Many variations and modifications may be made to the above described embodiments of the invention without departing substantially from the spirit and principles of the invention. All such modifications and variations are intended to be included herein within the scope of this disclosure and the present invention and protected by the following claims.

What is claimed is:

1. A stabilizing camera phone extension for use with a cellular phone, comprising:
a handle;
a paddle; and
a cell phone attachment;
wherein said handle is fixed to a lower side of said paddle;
wherein said paddle is a rectangular component which is wider than the handle and which further comprises a first face and a second face, said first face being adapted to interface with said cell phone attachment; and
wherein said cell phone attachment receives said cellular phone.

2. The stabilizing camera phone extension of claim 1, wherein:
the cell phone attachment is a replaceable adhesive patch comprising:
a strong adhesive;
an outer surface, said outer surface being bonded to a weak adhesive; and
the cell phone attachment interfaces with the first face of the paddle by adhering the strong adhesive to the paddle.

3. The stabilizing camera phone extension of claim 1, wherein:
the cell phone attachment is a grasper, said grasper comprising
a top portion attached to the paddle, said top portion comprising an upper pincer;
a bottom portion movably attached to the handle, said bottom portion comprising a lower pincer, a subordinate body, and a slider; and
wherein the handle further comprises a cut-out configured to allow the slider to move up, move down, or lock in place.

4. The stabilizing camera phone extension of claim 1, wherein the handle and the paddle are a single unitary piece.

5. The stabilizing camera phone extension of claim 4, wherein the single unitary piece comprises plastic.

6. A method of stabilizing cell phone video footage, the method comprising the steps of:
Placing a cell phone with at least one camera in the cell phone attachment such that a camera is facing away from a user

7. A tool for performing the method of claim 6, the tool comprising:
A main body, further comprising:
a handle;
a paddle; and
a cell phone attachment;
wherein said paddle is a rectangular component which is wider than the handle and which further comprises a first face and a second face, said first face being adapted to interface with said cell phone attachment; and
wherein said cell phone attachment receives said cellular phone.
